(19) United States
(12) Patent Application Publication
(10) Pub. No.: US 2026/0307468 A1
(43) Pub. Date: Oct. 8, 2026

(54) Reusable Door Assemblies for Vehicles

(71) Applicant: Textron Ground Support Equipment Inc., Cartersville, GA (US)

(72) Inventor: Alexandra Elizabeth Crump, Cartersville, GA (US)

(73) Assignee: Textron Ground Support Equipment Inc., Cartersville, GA (US)

(21) Appl. No.: 19/181,011

(22) Filed: Apr. 16, 2025

Related U.S. Application Data
(60) Provisional application No. 63/783,781, filed on Apr. 4, 2025.

(51) Int. Cl. B60J 5/04; B64F 1/225

(52) U.S. Cl. CPC B60J 5/0486; B60J 5/0468; B64F 1/225

(57) ABSTRACT

A ground support tractor includes a wheeled chassis having a cabin mounted thereon. A door assembly is coupled to the door frame of the cabin. A door assembly includes an upper channel coupled to an upper portion of the door frame, a lower channel coupled to a lower portion of the door frame, a forward touch fastener first half coupled to a forward portion of the door frame and an aft touch fastener first half coupled to an aft portion of the door frame. A flexible zip door has an upper sliding block that is slidably receivable by the upper channel, a lower sliding block that is slidably receivable by the lower channel, a forward touch fastener second half that is reclosably couplable with the forward touch fastener first half and an aft touch fastener second half that is reclosably couplable with the aft touch fastener first half.

### CROSS-REFERENCE TO RELATED APPLICATIONS

The present application claims the benefit of U.S. Provisional Application No. 63/783,781, filed Apr. 4, 2025.

### TECHNICAL FIELD OF THE DISCLOSURE

The present disclosure relates, in general, to reusable door assemblies for vehicles and, in particular, to reusable door assemblies for ground support tractors that utilize upper and lower slidable connections together with forward and aft touch connections to removably secure a reusable door to a door frame of the ground support tractor

### BACKGROUND

Ground support tractors, also known as airport tugs and aircraft tugs, are designed to perform a variety of tasks at airports. For example, certain ground support tractors are used to move and tow aircraft on the ground. These tractors safely maneuver aircraft in and out of hangars, on the tarmac and through other areas of the airport. They are essential for pushing aircraft back from the gate prior to departures and towing aircraft to maintenance or storage areas. As such, these ground support tractors ensure that aircraft are properly positioned, contributing to the smooth operation of the airport. Other ground support tractors are equipped with specialized attachments, such as cargo loaders or baggage carts. These tractors help move luggage, cargo containers and other types of freight between different areas of the airport. As a result, these ground support tractors streamline the process of loading, transporting and unloading cargo and baggage, ensuring that airport operations run efficiently.

Ground support tractors must be designed to operate in the diverse weather conditions experienced at airports. These tractors must function in a range of temperatures, humidities and wind speeds as well as in various types of precipitation including rain, sleet and snow. To ensure the safety and comfort of tractor operators, doors are typically installed on the cabin allowing for easy access while shielding the interior of the cabin from harsh outdoor environments. It has been found, however, that ground support tractors without doors can be advantageous in certain operating environments, particularly during the summer months. Attempts have been made to remove the doors from conventional ground support tractors, however, such door removal typically requires door replacement. Accordingly, a need has arisen for a ground support tractor featuring doors that are both removable and reusable, thereby offering flexibility while reducing expenses relating to replacement doors.

### SUMMARY

In a first aspect, the present disclosure is directed to a door assembly for a vehicle that has a door frame. The door assembly includes an upper channel coupled to an upper portion of the door frame, a lower channel coupled to a lower portion of the door frame, a forward touch fastener first half coupled to a forward portion of the door frame and an aft touch fastener first half coupled to an aft portion of the door frame. A flexible zip door has an upper sliding block, a lower sliding block, a forward touch fastener second half and an aft touch fastener second half. The upper sliding block is slidably receivable by the upper channel. The lower sliding block is slidably receivable by the lower channel. The forward touch fastener second half is reclosably couplable with the forward touch fastener first half. The aft touch fastener second half is reclosably couplable with the aft touch fastener first half.

In some embodiments, the upper channel and the lower channel may be parallel to each other. In certain embodiments, the upper channel may include an upper cylindrical track having a slot and the upper sliding block may include an upper sliding rod that is slidably receivable by the upper cylindrical track. In some embodiments, the lower channel may include a lower cylindrical track having a slot and the lower sliding block may include a lower sliding rod that is slidably receivable by the lower cylindrical track. In certain embodiments, the forward touch fastener first half and the forward touch fastener second half may be a touch fastener tape system. Likewise, the aft touch fastener first half and the aft touch fastener second half may be a touch fastener tape system. In some embodiments, the forward touch fastener first half and the aft touch fastener first half may be adhesively coupled to the door frame. In certain embodiments, the forward touch fastener second half and the aft touch fastener second half may be adhesively coupled to an interior surface of the flexible zip door. In other embodiments, the forward touch fastener second half and the aft touch fastener second half may be stitched to an interior surface of the flexible zip door.

In some embodiments, the flexible zip door may include a door frame attachment panel and a roll-up panel that are zipped together in a closed configuration of the flexible zip door and unzipped relative to each other in an open configuration of the flexible zip door. In certain embodiments, the flexible zip door may include upper and lower belts that are coupled to a forward portion of the door frame attachment panel and are configured to receive and secure the roll-up panel in the open configuration of the flexible zip door. In some embodiments, the door frame may include a floor panel frame and the flexible zip door may include a closeout panel that extends below the lower sliding block and is securably couplable to the floor panel frame. In certain embodiments, the flexible zip door may include at least one window. For example, the flexible zip door may include upper and lower windows.

In a second aspect, the present disclosure is directed to a vehicle that includes a cabin that has a door frame and a door assembly that is coupled to the cabin. The door assembly includes an upper channel coupled to an upper portion of the door frame, a lower channel coupled to a lower portion of the door frame, a forward touch fastener first half coupled to a forward portion of the door frame and an aft touch fastener first half coupled to an aft portion of the door frame. A flexible zip door has an upper sliding block, a lower sliding block, a forward touch fastener second half and an aft touch fastener second half. The upper sliding block is slidably receivable by the upper channel. The lower sliding block is slidably receivable by the lower channel. The forward touch fastener second half is reclosably couplable with the forward touch fastener first half. The aft touch fastener second half is reclosably couplable with the aft touch fastener first half.

In some embodiments, the flexible zip door may have an uninstalled configuration and an installed configuration relative to the cabin such that the flexible zip door translates in a longitudinal direction of the vehicle relative to the cabin to transition between the uninstalled configuration and the installed configuration with the upper sliding block sliding within the upper channel and the lower sliding block sliding within the lower channel. In certain embodiments, the flexible zip door may have an uninstalled configuration and an installed configuration relative to the cabin such that the flexible zip door translates in a forward longitudinal direction of the vehicle relative to the cabin to transition from the uninstalled configuration to the installed configuration with the upper sliding block sliding within the upper channel and the lower sliding block sliding within the lower channel and such that the flexible zip door translates in a aftward longitudinal direction of the vehicle relative to the cabin to transition from the installed configuration to the uninstalled configuration with the upper sliding block sliding within the upper channel and the lower sliding block sliding within the lower channel.

In a third aspect, the present disclosure is directed to a ground support tractor that includes a wheeled chassis with a cabin mounted thereto that has a door frame. A door assembly is coupled to the cabin. The door assembly includes an upper channel coupled to an upper portion of the door frame, a lower channel coupled to a lower portion of the door frame, a forward touch fastener first half coupled to a forward portion of the door frame and an aft touch fastener first half coupled to an aft portion of the door frame. A flexible zip door has an upper sliding block, a lower sliding block, a forward touch fastener second half and an aft touch fastener second half. The upper sliding block is slidably receivable by the upper channel. The lower sliding block is slidably receivable by the lower channel. The forward touch fastener second half is reclosably couplable with the forward touch fastener first half. The aft touch fastener second half is reclosably couplable with the aft touch fastener first half.

In some embodiments, the flexible zip door may have an uninstalled configuration and an installed configuration relative to the cabin such that the flexible zip door translates in a longitudinal direction of the ground support tractor relative to the cabin to transition between the uninstalled configuration and the installed configuration with the upper sliding block sliding within the upper channel and the lower sliding block sliding within the lower channel. In certain embodiments, the flexible zip door may have an uninstalled configuration and an installed configuration relative to the cabin such that the flexible zip door translates in a forward longitudinal direction of the ground support tractor relative to the cabin to transition from the uninstalled configuration to the installed configuration with the upper sliding block sliding within the upper channel and the lower sliding block sliding within the lower channel and such that the flexible zip door translates in a aftward longitudinal direction of the ground support tractor relative to the cabin to transition from the installed configuration to the uninstalled configuration with the upper sliding block sliding within the upper channel and the lower sliding block sliding within the lower channel.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 is a schematic illustration of a ground support tractor that has reusable door assemblies installed thereon that is towing a baggage cart in accordance with embodiments of the present disclosure;

FIGS. 2A-2D are isometric views of a ground support tractor in various states of assembly to reveal component parts thereof in accordance with embodiments of the present disclosure;

FIGS. 3A-3B are side views of a ground support tractor that has reusable door assemblies being installed thereon in accordance with embodiments of the present disclosure;

FIGS. 4A-4D are side views of a door frame of a ground support tractor cabin in various configurations relative to a reusable door assembly in accordance with embodiments of the present disclosure;

FIG. 5 is an isometric view of a ground support tractor cabin depicting the installation and removal processes for reusable door assemblies in accordance with embodiments of the present disclosure; and

FIGS. 6A-6C are isometric views detailing connections between a reusable door assembly and a door frame of a ground support tractor cabin in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the devices described herein may be oriented in any desired direction. As used herein, the term “coupled” may include direct or indirect coupling by any means, including by mere contact or by moving and/or non-moving mechanical connections.

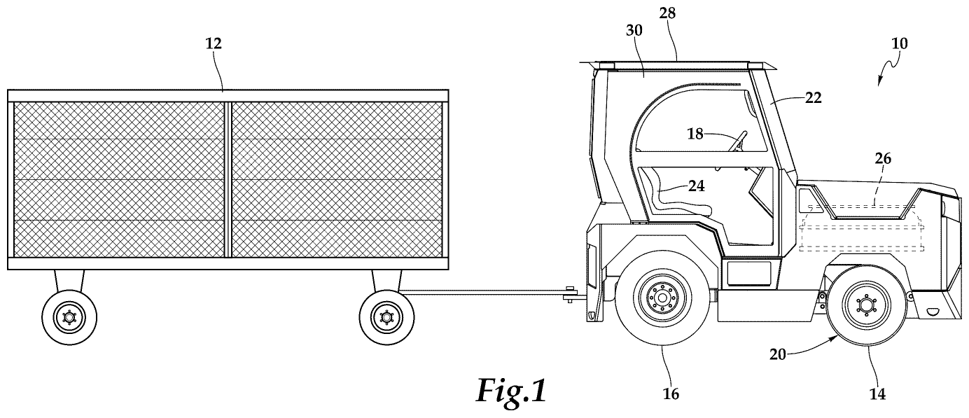

Referring to FIG. 1 in the drawings, a land vehicle depicted as a ground support tractor is schematically illustrated and generally designated 10. In the illustrated embodiment, ground support tractor 10 is towing a load depicted as a cargo container 12 at an airport, such as between the terminal and a cargo hold of an aircraft. Ground support tractor 10 is a wheeled vehicle that includes a pair of front steering control wheels 14 and a pair of aft drive wheels 16. Front steering control wheels 14 of ground support tractor 10 are respectively positioned within front wheel wells which are sized to allow rotation and turning of front steering control wheels 14 therein to control the direction of travel of ground support tractor 10 when ground support tractor 10 is moving. Ground support tractor 10 includes a steering system coupled to front steering control wheels 14 including a steering controller 18 that is operably coupled to front steering control wheels 14 such that rotation of steering controller 18 causes front steering control wheels 14 to turn. Aft drive wheels 16 of ground support tractor 10 are respectively positioned within aft wheel wells which are sized to allow rotation of aft drive wheels 16 therein to control the movement of ground support tractor 10.

Ground support tractor 10 includes motion controllers such as pedals (not visible) for accelerating and stopping ground support tractor 10. For example, an accelerator pedal is operably coupled to a powertrain of ground support tractor 10 that provides torque to aft drive wheels 16. A brake pedal is operably coupled to a brake system that is coupled to front steering control wheels 14 and/or aft drive wheels 16 to stop the motion of ground support tractor 10. Structural support for ground support tractor 10 includes a chassis, depicted as wheeled chassis 20, on or around which the various components of ground support tractor 10 are assembled. In the illustrated embodiment, ground support tractor 10 has a cab aft configuration wherein a cabin 22 and a seat assembly 24 are positioned aft of the power source of ground support tractor 10 depicted as a battery system 26. In other embodiments, a ground support tractor of the present disclosure could have a cab forward configuration in which the cabin and a seat assembly are positioned forward of the power source. As ground support tractor 10 must operate in the diverse weather conditions experienced at airports including, for example, in a range of temperatures, humidities and wind speeds as well as in various types of precipitation such as rain, sleet and snow, cabin 22 has a roof 28 as well as door assemblies 30 on the left side and right side of cabin 22. Door assemblies 30 ensure the safety and comfort of the operators of ground support tractor 10, allowing easy access to cabin 22 while shielding the interior of cabin 22 from harsh outdoor environments. In certain environments, particularly during the summer months, it can be desirable to operate a ground support tractor without doors. With conventional ground support tractors, however, door removal typically requires door replacement as the doors are designed for permanent attachment to the cabin and removal of the doors typically results in damage to the doors. Door assemblies 30 of the present disclosure, however, are advantageously removeable and also reusable, thereby offering flexibility while reducing expenses relating to replacement doors.

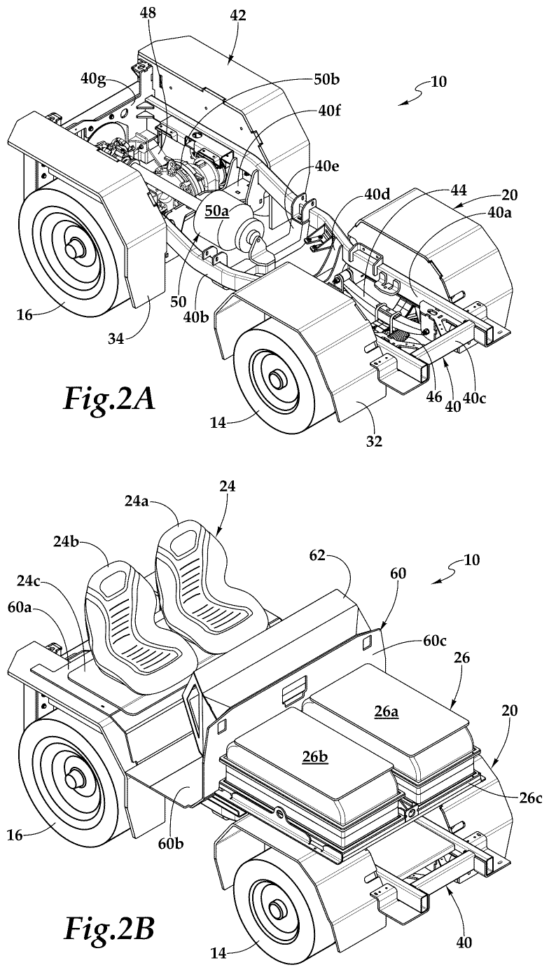

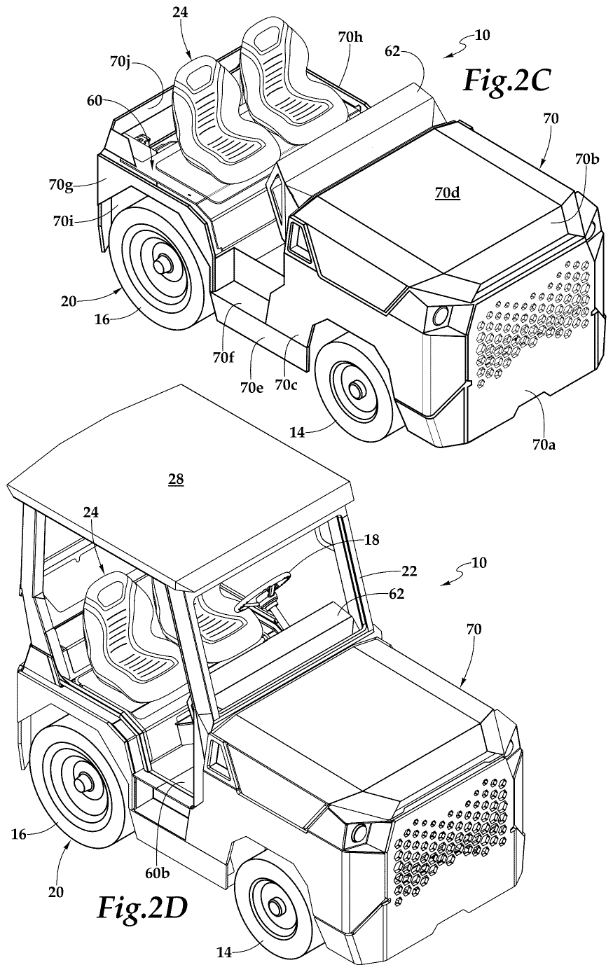

Referring next to FIGS. 2A-2D of the drawings, certain components of ground support tractor 10 will be discussed. As best seen in FIG. 2A, wheeled chassis 20 is formed of a plurality of structural members that are interconnected by welds, bolts and/or other suitable fastening means. The structural members include a frame assembly 40 and a plurality of plate members 42 comprised of metal or metal alloy, such as steel or aluminum. Frame assembly 40 includes a left beam 40a, a right beam 40b, a front mounting rail 40c, a front suspension mount 40d, a motor mount 40e, an aft suspension mount 40f and an aft hitch plate 40g. Plate members 42 form front wheel wells 32 and aft wheel wells 34 each of which is coupled to frame assembly 40. A front suspension 44, depicted as leaf springs, is mounted between front mounting rail 40c and a front suspension mount 40d with a steering rack 46 coupled to front suspension 44. A rear suspension 48, depicted as leaf springs, is coupled between aft suspension mount 40f and aft hitch plate 40g. In the illustrated embodiment, a drivetrain 50, depicted as including an electric motor 50a and a transaxle 50b, is coupled between motor mount 40e and rear suspension 48. Transaxle 50b is operably coupled to the drive axles that provide torque to aft drive wheels 16.

As best seen in FIG. 2B, an operator tub 60 is coupled to wheeled chassis 20. Operator tub 60 is preferably a single integral plate member but could alternatively be formed from multiple plate sections that are coupled together or separately coupled to wheeled chassis 20. Operator tub 60 is comprised of metal or metal alloy, such as steel or aluminum. In the illustrated embodiment, operator tub 60 include a generally horizontally extending aft plate 60a, a cabin floor 60b and a generally vertically extending forward plate 60c. A dash frame 62 is coupled to forward plate 60c. Battery system 26 is coupled to wheeled chassis 20 and includes battery packs 26a, 26b that are mounted on a battery rack 26c. In the illustrated embodiment, battery packs 26a, 26b are operably coupled to drivetrain 50 to form the powertrain of ground support tractor 10. In other embodiments, the powertrain of a ground support tractor may include an internal combustion engine and a transmission. Battery packs 26a, 26b provide the energy necessary to power electric motor 50a and thus the movement of ground support tractor 10 as well as the various electronic components thereof. Seat assembly 24 including a driver seat 24a, a passenger seat 24b and a seat frame 24c that is coupled to aft plate 60a of operator tub 60 and/or wheeled chassis 20.

As best seen in FIG. 2C, ground support tractor 10 including a plurality of body panels 70 that provide an outer skin for ground support tractor 10 that protects the various operating components disposed therein. In the illustrated embodiments, body panels 70 include a front bumper 70a, a headlight bezel 70b, a right front fender 70c, a left front fender (not visible), a hood 70d, a right side skirt 70e, a left side skirt (not visible), a right cab step 70f, a left cab step (not visible), a right rear fender 70g, a left rear fender 70h, a rear bumper 70i and a service access panel 70j. Body panels 70 are comprised of metal or metal alloy, such as steel or aluminum. As best seen in FIG. 2D, ground support tractor 10 includes cabin 22 that is mounted on wheeled chassis 20 above cabin floor 60b to provide an enclosure for the operators of ground support tractor 10.

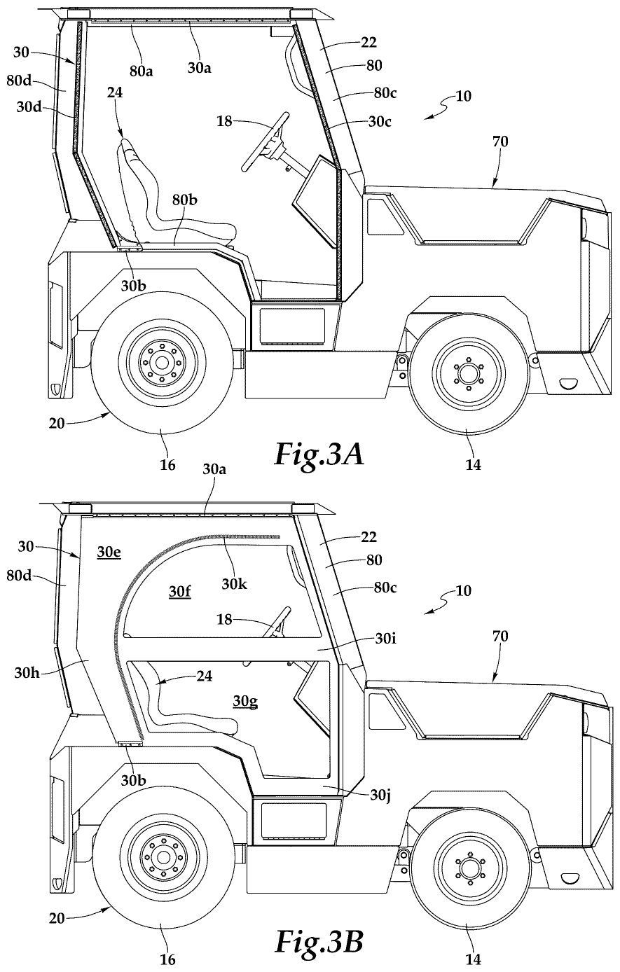

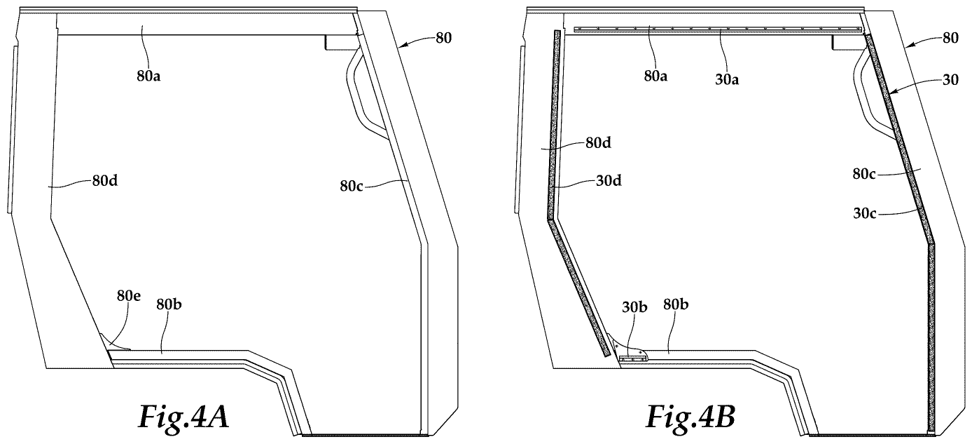

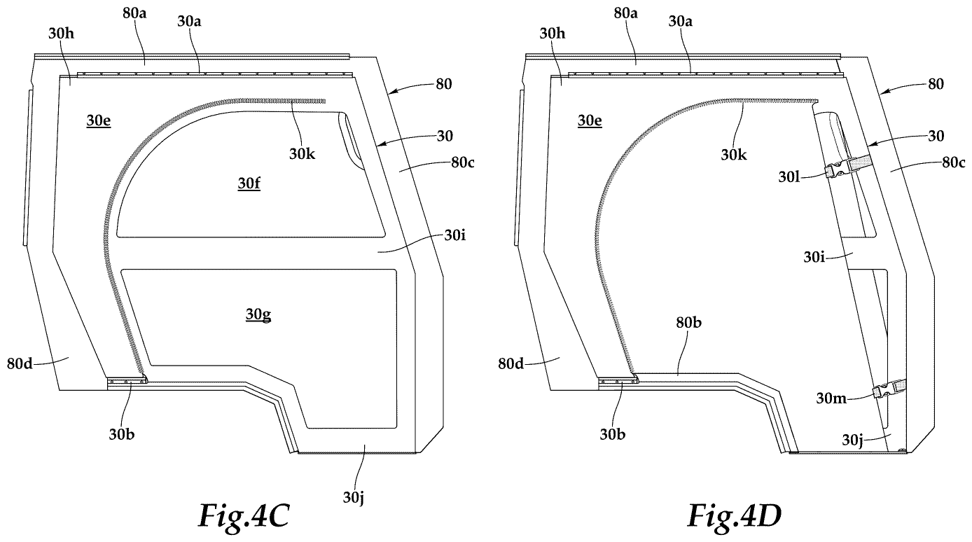

Referring additionally to FIGS. 3A-3B of the drawings, a right side view of ground support tractor 10 is depicted. It is noted that the left side of ground support tractor 10 is substantially similar to the right side of ground support tractor 10 therefore, for sake of efficiency, certain features will be disclosed only with regard to the right side of ground support tractor 10. One having ordinary skill in the art, however, will fully appreciate an understanding of the left side of ground support tractor 10 based upon the disclosure herein of the right side of ground support tractor 10. Cabin 22 includes a door frame 80 having an upper portion 80a, a lower portion 80b, a forward portion 80c and an aft portion 80d (see also FIG. 4A). A mounting bracket 80e is positioned between lower portion 80b and an aft portion 80d.

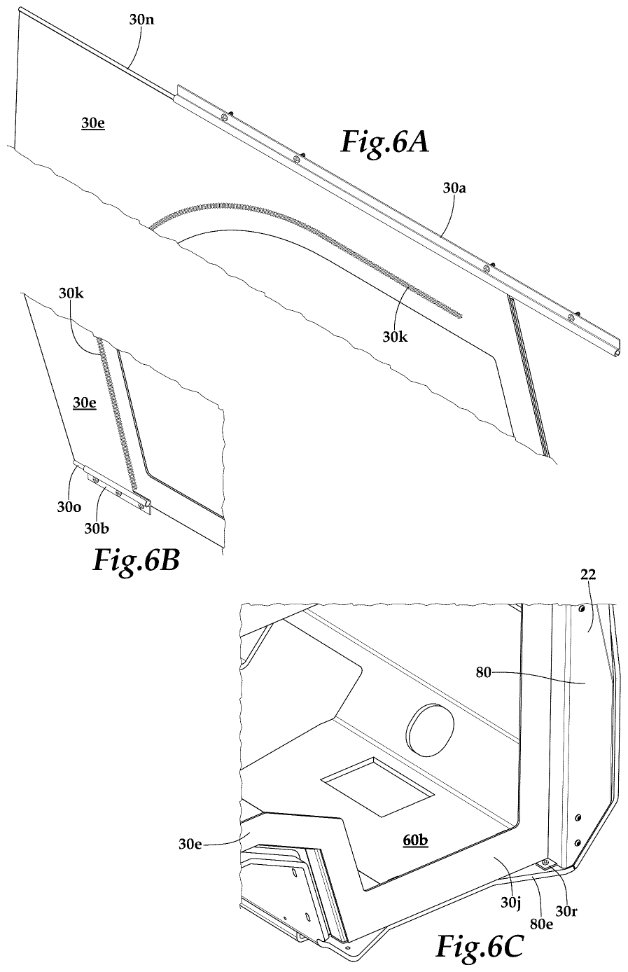

As best seen in FIG. 3A, a fixed portion of door assembly 30 is securably coupled to door frame 80. The fixed portion of door assembly 30 includes an upper channel 30a, a lower channel 30b, a forward touch fastener first half 30c and an aft touch fastener first half 30d. In the illustrated embodiment, upper channel 30a is coupled to upper portion 80a of door frame 80 using suitable fasteners depicted as screws (see also FIG. 4B). Lower channel 30b is coupled to lower portion 80b of door frame 80 and mounting bracket 80e using a support bracket and suitable fasteners depicted as screws. Upper channel 30a and lower channel 30b may be formed from a metal such as aluminum. In the illustrated embodiment, upper channel 30a and lower channel 30b are parallel to each other and extend in the longitudinal direction of ground support tractor 10. Upper channel 30a forms a cylindrical track having a slot therein, as best seen in FIG. 6A. Lower channel 30b forms a cylindrical track having a slot therein, as best seen in FIG. 6B.

Forward touch fastener first half 30c is coupled to forward portion 80c of door frame 80 via an adhesive backing on a rear surface of forward touch fastener first half 30c that adheres forward touch fastener first half 30c to forward portion 80c of door frame 80. Aft touch fastener first half 30d is coupled to aft portion 80d of door frame 80 via an adhesive backing on a rear surface of aft touch fastener first half 30d that adheres aft touch fastener first half 30d to aft portion 80d of door frame 80. In the illustrated embodiment, forward touch fastener first half 30c includes upper and lower sections. In other embodiments, a forward touch fastener first half could include other numbers of sections both less than or greater than two. Likewise, aft touch fastener first half 30d includes upper and lower sections. In other embodiments, an aft touch fastener first half could include other numbers of sections both less than or greater than two. Forward touch fastener first half 30c and aft touch fastener first half 30d may each represent one half of a touch fastener tape system such as a hook and loop tape system or a hook and hook tape system.

As best seen in FIG. 3B, a removeable and reusable portion of door assembly 30, referred to herein as flexible zip door 30e, has been coupled to the fixed portion of door assembly 30 and thus installed on door frame 80. Flexible zip door 30e may be formed from a flexible polyvinyl chloride or other suitably flexible material. In the illustrated embodiment, flexible zip door 30e includes an upper window 30f and a lower window 30g (see also FIG. 4C). In other embodiments, a flexible zip door of the present disclosure could include other numbers of windows both less than or greater than two. In the illustrated embodiment, flexible zip door 30e includes a door frame attachment panel 30h and a roll-up panel 30i with a closeout panel 30j that are selectively mated together with a zipper 30k. When door frame attachment panel 30h and roll-up panel 30i are zipped together, flexible zip door 30e is in a closed configuration as depicted in FIGS. 3B and 4C. In the closed configuration, flexible zip door 30e protects the inside of cabin 22 and the operators of ground support tractor 10 from unpleasant outdoor environments such as wind, rain, snow and ice. In addition, a closed flexible zip door 30e helps to maintain a desired temperature within cabin 22 by retaining warmed air in the winter and retaining cooled air in summer. When zipper 30k is in an unzipped position and roll-up panel 30i is free to move relative to door frame attachment panel 30h, flexible zip door 30e is in an open configuration allowing operators to enter and exit cabin 22. When flexible zip door 30e is in the open configuration, roll-up panel 30i may be temporarily stowed in a rolled up configuration using upper belt 301 and lower belt 30m that are coupled to a forward portion of door frame attachment panel 30h to secure roll-up panel 30i in place, as best seen in FIG. 4D.

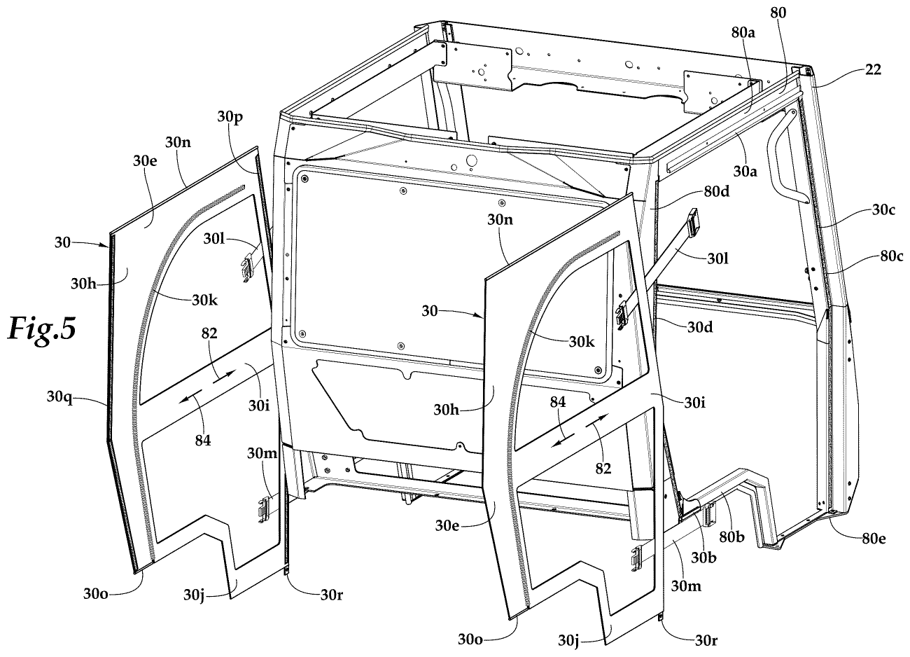

Referring additionally to FIG. 5 of the drawings, the installation and removal of flexible zip doors 30e will be described. Each of flexible zip doors 30e includes an upper sliding block depicted as an upper sliding rod 30n, a lower sliding block depicted as a lower sliding rod 300, a forward touch fastener second half 30p and an aft touch fastener second half 30q. Upper sliding rod 30n and lower sliding rod 300 may be formed from a stiff material including rigid polyvinyl chloride, a metal insert positioned within upper and lower polyvinyl chloride pockets or a braided rope embedded within a polyvinyl chloride sheath. Forward touch fastener second half 30p is coupled to a forward inside portion of flexible zip doors 30e via an adhesive backing, stitching or a combination thereof. Likewise, aft touch fastener second half 30q is coupled to an aft inside portion of flexible zip doors 30e via an adhesive backing, stitching or a combination thereof. Forward touch fastener second half 30p and aft touch fastener second half 30q may each represent one half of a touch fastener tape system such as a hook and loop tape system or a hook and hook tape system.

In the illustrated embodiment, when one of flexible zip doors 30e is aligned with a door frame 80 and is translated relative thereto in the forward longitudinal direction of ground support tractor 10, as indicated by arrows 82, a forward end of upper sliding rod 30n enters an aft end of upper channel 30a. As flexible zip door 30e translates further in the forward longitudinal direction, upper sliding rod 30n slides within upper channel 30a with a portion of flexible zip door 30e sliding within the slot of upper channel 30a, as best seen in FIG. 6A. As flexible zip door 30e translates further in the forward longitudinal direction, a forward end of lower sliding rod 300 enters an aft end of lower channel 30b. Now, as flexible zip door 30e translates further in the forward longitudinal direction, upper sliding rod 30n slides within upper channel 30a and lower sliding rod 300 slides within lower channel 30b with a portion of flexible zip door 30e sliding within the slot of lower channel 30b, as best seen in FIG. 6B.

Flexible zip door 30e reached full travel in the forward longitudinal direction when forward touch fastener second half 30p is aligned with forward touch fastener first half 30c and aft touch fastener second half 30q is aligned with aft touch fastener first half 30d. In this position, a pressing action may be used to releasably couple forward touch fastener second half 30p with forward touch fastener first half 30c. Likewise, a pressing action may be used to releasably couple aft touch fastener second half 30q with aft touch fastener first half 30d. Also, in this position, perforated tab 30r on the bottom of closeout panel 30j aligns with a perforated floor panel frame 80e of door frame 80 such that a fastener such as a screw may be used to secure closeout panel 30j to floor panel frame 80e, as best seen in FIG. 6C. This is considered the installed configuration of flexible zip door 30e. As used herein the term closeout panel refers to the portion of flexible zip door 30e that extends below lower sliding rod 300 and is used to cover the reduced elevation portion of cabin 22 down to cabin floor 60b. The use of closeout panel 30j protects the inside of cabin 22 and the operators of ground support tractor 10 from unpleasant outdoor environments such as wind, rain, snow and ice. In addition, closeout panel 30j helps to maintain a desired temperature within cabin 22 by retaining warmed air in the winter and retaining cooled air in summer.

When it is desired to have an open air cabin configuration, flexible zip doors 30e may be removed from ground support tractor 10. This process includes, removing the fastener securing closeout panel 30j to floor panel frame 80e. In addition, forward touch fastener second half 30p is separated from forward touch fastener first half 30c and aft touch fastener second half 30q is separated from aft touch fastener first half 30d using, for example, a pulling action. Now, flexible zip door 30e may translate in the aftward longitudinal direction of ground support tractor 10 relative to door frame 80, as indicated by arrows 84, which causes upper sliding rod 30n to slide within upper channel 30a and lower sliding rod 300 to slide within lower channel 30b. After a first portion of this aftward translation, the forward portion of lower sliding rod 300 exits the aft portion of lower channel 30b. Now, further translation of flexible zip door 30e in the aftward longitudinal direction causes upper sliding rod 30n to slide within upper channel 30a until the forward portion of upper sliding rod 30n exits the aft portion of upper channel 30a returning flexible zip doors 30e to an uninstalled configuration.

As the removal of flexible zip doors 30e from cabin 22 does not cause any damage to flexible zip doors 30e or cabin 22, when it is desired to return ground support tractor 10 to a fully enclosed cabin configuration, flexible zip doors 30e are simply reinstalled on cabin 22 in accordance with the procedure described herein. Accordingly, in the installed configuration, door assemblies 30 not only provide easy entry and exit from cabin 22, in the open configuration, but also provide protection from unpleasant outdoor environments for the operators of ground support tractor 10, in the closed configuration. In addition, due to the reusable design, door assemblies 30 may be repetitively transitioned between the installed configuration and the uninstalled configuration depending upon whether an open air cabin configuration or a fully enclosed cabin configuration is desired.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. A door assembly for a vehicle having a door frame, the door assembly comprising:
an upper channel coupled to an upper portion of the door frame;
a lower channel coupled to a lower portion of the door frame;
a forward touch fastener first half coupled to a forward portion of the door frame;
an aft touch fastener first half coupled to an aft portion of the door frame; and
a flexible zip door having an upper sliding block, a lower sliding block, a forward touch fastener second half and an aft touch fastener second half;
wherein, the upper sliding block is slidably receivable by the upper channel;
wherein, the lower sliding block is slidably receivable by the lower channel;
wherein, the forward touch fastener second half is reclosably couplable with the forward touch fastener first half; and
wherein, the aft touch fastener second half is reclosably couplable with the aft touch fastener first half.

2. The door assembly as recited in claim 1 wherein, the upper channel and the lower channel are parallel to each other.

3. The door assembly as recited in claim 1 wherein, the upper channel further comprises an upper cylindrical track having a slot; and
wherein, the upper sliding block further comprises an upper sliding rod that is slidably receivable by the upper cylindrical track.

4. The door assembly as recited in claim 1 wherein, the lower channel further comprises a lower cylindrical track having a slot; and
wherein, the lower sliding block further comprises a lower sliding rod that is slidably receivable by the lower cylindrical track.

5. The door assembly as recited in claim 1 wherein, the forward touch fastener first half and the forward touch fastener second half further comprise a touch fastener tape system.

6. The door assembly as recited in claim 1 wherein, the aft touch fastener first half and the aft touch fastener second half further comprise a touch fastener tape system.

7. The door assembly as recited in claim 1 wherein, the forward touch fastener first half and the aft touch fastener first half are adhesively coupled to the door frame.

8. The door assembly as recited in claim 1 wherein, the forward touch fastener second half and the aft touch fastener second half are adhesively coupled to an interior surface of the flexible zip door.

9. The door assembly as recited in claim 1 wherein, the forward touch fastener second half and the aft touch fastener second half are stitched to an interior surface of the flexible zip door.

10. The door assembly as recited in claim 1 wherein, the flexible zip door further comprises a door frame attachment panel and a roll-up panel that are zipped together in a closed configuration of the flexible zip door and unzipped relative to each other in an open configuration of the flexible zip door.

11. The door assembly as recited in claim 10 wherein, the flexible zip door further comprises upper and lower belts coupled to a forward portion of the door frame attachment panel, the upper and lower belts configured to receive and secure the roll-up panel in the open configuration of the flexible zip door.

12. The door assembly as recited in claim 1 wherein, the door frame further comprises a floor panel frame; and
wherein, the flexible zip door further comprises a closeout panel that extends below the lower sliding block, the closeout panel securably couplable to the floor panel frame.

13. The door assembly as recited in claim 1 wherein, the flexible zip door further comprises at least one window.

14. The door assembly as recited in claim 1 wherein, the flexible zip door further comprises upper and lower windows.

15. A vehicle comprising:
a cabin having a door frame; and
a door assembly coupled to the cabin, the door assembly including:
an upper channel coupled to an upper portion of the door frame;
a lower channel coupled to a lower portion of the door frame;
a forward touch fastener first half coupled to a forward portion of the door frame;
an aft touch fastener first half coupled to an aft portion of the door frame; and
a flexible zip door having an upper sliding block, a lower sliding block, a forward touch fastener second half and an aft touch fastener second half;
wherein, the upper sliding block is slidably receivable by the upper channel;
wherein, the lower sliding block is slidably receivable by the lower channel;
wherein, the forward touch fastener second half is reclosably couplable with the forward touch fastener first half; and
wherein, the aft touch fastener second half is reclosably couplable with the aft touch fastener first half.

16. The vehicle as recited in claim 15 wherein, the flexible zip door has an uninstalled configuration and an installed configuration relative to the cabin; and
wherein, the flexible zip door translates in a longitudinal direction of the vehicle relative to the cabin to transition between the uninstalled configuration and the installed configuration with the upper sliding block sliding within the upper channel and the lower sliding block sliding within the lower channel.

17. The vehicle as recited in claim 15 wherein, the flexible zip door has an uninstalled configuration and an installed configuration relative to the cabin;
wherein, the flexible zip door translates in a forward longitudinal direction of the vehicle relative to the cabin to transition from the uninstalled configuration to the installed configuration with the upper sliding block sliding within the upper channel and the lower sliding block sliding within the lower channel; and
wherein, the flexible zip door translates in an aftward longitudinal direction of the vehicle relative to the cabin to transition from the installed configuration to the uninstalled configuration with the upper sliding block sliding within the upper channel and the lower sliding block sliding within the lower channel.

18. A ground support tractor comprising:
a wheeled chassis;
a cabin mounted on the wheeled chassis, the cabin having a door frame; and
a door assembly coupled to the cabin, the door assembly including:
an upper channel coupled to an upper portion of the door frame;
a lower channel coupled to a lower portion of the door frame;
a forward touch fastener first half coupled to a forward portion of the door frame;
an aft touch fastener first half coupled to an aft portion of the door frame; and
a flexible zip door having an upper sliding block, a lower sliding block, a forward touch fastener second half and an aft touch fastener second half;
wherein, the upper sliding block is slidably receivable by the upper channel;
wherein, the lower sliding block is slidably receivable by the lower channel;
wherein, the forward touch fastener second half is reclosably couplable with the forward touch fastener first half; and
wherein, the aft touch fastener second half is reclosably couplable with the aft touch fastener first half.

19. The ground support tractor as recited in claim 18 wherein, the flexible zip door has an uninstalled configuration and an installed configuration relative to the cabin; and
wherein, the flexible zip door translates in a longitudinal direction of the ground support tractor relative to the cabin to transition between the uninstalled configuration and the installed configuration with the upper sliding block sliding within the upper channel and the lower sliding block sliding within the lower channel.

20. The ground support tractor as recited in claim 18 wherein, the flexible zip door has an uninstalled configuration and an installed configuration relative to the cabin;
wherein, the flexible zip door translates in a forward longitudinal direction of the ground support tractor relative to the cabin to transition from the uninstalled configuration to the installed configuration with the upper sliding block sliding within the upper channel and the lower sliding block sliding within the lower channel; and
wherein, the flexible zip door translates in an aftward longitudinal direction of the ground support tractor relative to the cabin to transition from the installed configuration to the uninstalled configuration with the upper sliding block sliding within the upper channel and the lower sliding block sliding within the lower channel.
